(19) United States
(12) Patent Application Publication
(10) Pub. No.: US 2019/0390812 A1
(43) Pub. Date: Dec. 26, 2019

(54) PLASTIC PIPELINE

(71) Applicant: ContiTech Kühner GmbH & Cie KG, Oppenweiler (DE)

(72) Inventor: Jonathan Messerschmidt, Murrhardt (DE)

(73) Assignee: ContiTech Kühner GmbH & Cie KG, Oppenweiler (DE)

(21) Appl. No.: 16/446,672

(22) Filed: Jun. 20, 2019

(30) Foreign Application Priority Data
Jun. 22, 2018 (DE) 10 2018 210 209.0

(51) Int. Cl. F16L 47/32

(52) U.S. Cl. CPC F16L 47/32

(57) ABSTRACT

The invention relates to a plastic pipeline (1), having at least one radial branch. The invention is based on the object of providing a plastic pipeline (1) having a radial branch (4, 5) that avoids the problems of the known configurations. This object is achieved by the plastic pipeline (1) having in the intended region of the branching a bore (2) and a saddle-shaped plastic element (4, 5) with a through-bore (6), the through-bore (6) of the saddle-shaped plastic element (4, 5) being in line with the bore (2) in the plastic pipeline (1) and the saddle-shaped plastic element (4, 5) being formed from a plastics material that can be fused with the material of the plastic pipeline (1), and the saddle-shaped plastic element (4, 5) being connected to the plastic pipeline (1) in a pressure- and fluid-tight manner.

The invention relates to a plastic pipeline, having at least one radial branch.

According to the prior art, radial branches on plastic pipelines often take the form of T pieces inserted axially into the plastic pipeline. The T pieces then have a predetermined, minimum permissible axial length, by which the plastic pipeline must be shortened in order to be able to insert the T piece. Consequently, the application range of T pieces is restricted when there are confined installation conditions.

Therefore, further solutions that alleviate this problem have been developed, for example tapping sleeves or the like. Thus, DE 102 51 826 A1 shows a branch of a pipeline in the case of which the pipeline is drilled into laterally and an annular sleeve of plastic with the branch is molded around the pipeline in the region around the drilling point. In this case, the seal-tightness of this branch is dependent on the shrinking properties of the overmolded plastic, which can be problematic if contact surfaces between the pipeline and the annular sleeve are not optimally formed.

EP 0 580 222 B1 discloses a branching connection for a plastic pipeline in the case of which a saddle-shaped element can be securely clamped on the plastic pipeline by means of a clamping device. The saddle-shaped element also serves in this case as an auxiliary device for guiding a tapping device that can be introduced into the branching connection. Here, too, the seal-tightness of the branching connection after the tapping of the plastic pipeline is only provided by the frictional contact between the saddle-shaped element and the plastic pipeline, and is also dependent on the clamping force of the clamping device.

The invention is based on the object of providing a plastic pipeline having a radial branch that avoids the problems of the known configurations.

This object is achieved by the plastic pipeline having in the intended region of the branching a bore and a saddle-shaped plastic element with a through-bore, the through-bore of the plastic element being in line with the bore in the plastic pipeline and the saddle-shaped plastic element being formed from a plastics material that can be fused with the material of the plastic pipeline, and the saddle-shaped plastic element being connected to the plastic pipeline in a pressure- and fluid-tight manner.

Such an arrangement has the advantage that only a small installation space is required for the branch. The form of the branch can be designed with great variety by suitable shaping of the saddle-shaped plastic element.

In a development of the invention, the saddle-shaped plastic element is formed as a plastic injection-molded part.

Different geometries for the saddle-shaped plastic elements can be created in an easy way by means of the injection molding of plastics. Thus, the saddle-shaped plastic element can be adapted to the different diameters of the plastic pipeline. In this way, saddle-shaped plastic elements can be created even for branches on bends of the plastic pipeline.

In a development of the invention, the saddle-shaped plastic element can be connected to the plastic pipeline without further additional materials by making the two plastics materials of the plastic pipeline and of the saddle-shaped plastic element begin to melt by means of a laser beam.

The seal-tightness of the connection can be ensured well by the laser welding known per se. By dispensing with additional materials, the welding process is possible even without complex feeding devices.

In a development of the invention, the saddle-shaped plastic element is at least partially made up of a laser-transparent material.

Laser-transparent material has the advantage that laser welding is possible even in the contact zone between the saddle-shaped plastic element and the plastic pipeline.

In a development of the invention, the laser-transparent saddle-shaped plastic element is welded to the plastic pipeline securely and fluid-tightly by laser welding in the contact zone between the saddle-shaped plastic element and the plastic pipeline.

The welding in the contact zone has the advantage that even a number of annular weld seams can be arranged around the bore of the plastic pipeline. Furthermore, the path covered by the laser beam has to meet lower accuracy requirements.

In a development of the invention, a coating of an elastomeric material is arranged on the saddle-shaped plastic element, on its surface facing the plastic pipeline.

Such a coating has the advantage that it can be effective as a seal between the components of the branch. The elastomer material is also melted during the laser welding, so that the welding is not impaired. For example, such a layer can be applied during the injection-molding of the saddle-shaped plastic element by two-component injection molding.

An example of the invention is explained in more detail below on the basis of the drawing.

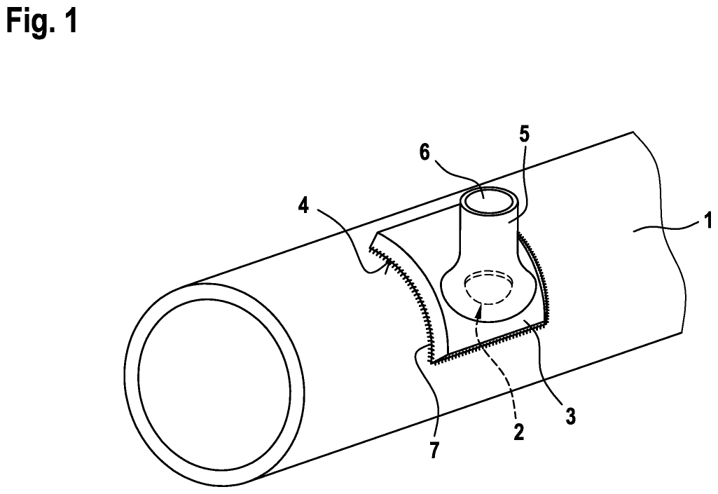

FIG. 1 shows a perspective basic view of a plastic pipe 1 according to the invention. The plastic pipeline 1 has a bore 2, which in this view is completely covered by a saddle-shaped plastic element 3 and is therefore represented by dashed lines. The saddle-shaped plastic element 3 has a curved contact surface 4, corresponding to the plastic pipeline 1, and a connector piece 5 with a bore 6. The contact surface 4 and the connector piece 5 are formed in one piece as a plastic injection-molded part. The bore 6 of the connector piece 5 is in line with the bore 2 in the plastic pipeline 1, so that it is possible for fluid to pass through.

The saddle-shaped plastic element 3 is connected to the plastic pipe 1 by a weld seam 7, the weld seam 7 being formed without any additional material by means of making the surfaces of the plastic pipe 1 and the contact surface 4 begin to melt by a laser beam.

### LIST OF REFERENCE SIGNS

### Part of the Description

1 Plastic pipeline
2 Bore in the plastic pipeline 1
3 Saddle-shaped plastic element
4 Contact surface of the saddle-shaped plastic element 3
5 Connector piece of the saddle-shaped plastic element 3
6 Bore of the connector piece 5
7 Weld seam between the plastic pipeline 1 and the saddle-shaped plastic element 3

1.-6. (canceled)

7. A plastic pipeline comprising at least one radial branch, wherein at the at the least one radial branch, the plastic pipeline comprises a bore and a saddle-shaped plastic element having a through-bore, wherein the through-bore of the saddle-shaped plastic element is in line with the bore of the plastic pipeline; and,
wherein the saddle-shaped plastic element is formed of a plastics material that is fused with the material of the plastic pipeline, and wherein the saddle-shaped plastic element is connected to the plastic pipeline in a pressure-tight and fluid-tight manner.

8. The plastic pipeline as claimed in claim 7, wherein the saddle-shaped plastic element is a plastic injection-molded part.

9. The plastic pipeline as claimed in claim 7, wherein the saddle-shaped plastic element is connected to the plastic pipeline without further additional materials by making the materials of the plastic pipeline and of the saddle-shaped plastic element fused by a laser beam.

10. The plastic pipeline as claimed in claim 7, wherein the saddle-shaped plastic element is at least partially comprised of a laser-transparent material.

11. The plastic pipeline as claimed in claim 10, wherein the laser-transparent saddle-shaped plastic element is welded to the plastic pipeline securely and fluid-tightly by laser welding in a contact zone between the saddle-shaped plastic element and the plastic pipeline.

12. The plastic pipeline as claimed in claim 7, wherein a coating of an elastomeric material is arranged on the saddle-shaped plastic element at a surface facing the plastic pipeline.

13. The plastic pipeline as claimed in claim 12, wherein the coating of an elastomeric material provides a seal between components of the branch

14. The plastic pipeline as claimed in claim 7, wherein a plurality of annular weld seams are arranged around the bore of the plastic pipeline.
